(19) United States
(12) Patent Application Publication
(10) Pub. No.: US 2025/0372783 A1
(43) Pub. Date: Dec. 4, 2025

(54) ENERGY STORAGE APPARATUS

(71) Applicant: GS Yuasa International Ltd., Kyoto-shi, Kyoto (JP)

(72) Inventors: Takashi IKEDA, Kyoto-shi, Kyoto (JP); Ibuki WATANO, Kyoto-shi, Kyoto (JP)

(21) Appl. No.: 18/876,625

(22) PCT Filed: Jun. 23, 2023
(86) PCT No.: PCT/JP2023/023252

§ 371 Date: Dec. 18, 2024

(30) Foreign Application Priority Data
Jun. 24, 2022 (JP) 2022-102029

(51) Int. Cl. H01M 50/242; H01M 50/209; H01M 50/55; H01M 50/591

(52) U.S. Cl. CPC H01M 50/242; H01M 50/209; H01M 50/55; H01M 50/591

(57) ABSTRACT

An energy storage apparatus includes an energy storage device unit including an energy storage device and an external terminal, in which the external terminal is disposed on an end portion of the energy storage device unit in a first direction, the energy storage device unit further includes a side member disposed in a second direction with respect to the energy storage device, the second direction intersecting the first direction, and the side member includes a projecting portion projecting more than the external terminal in the first direction.

### CROSS REFERENCE TO RELATED APPLICATIONS

This application is a National Stage Application, filed under 35 U.S.C. § 371, of International Application No. PCT/JP2023/023252, filed Jun. 23, 2023, which international application claims priority to and the benefit of Japanese Application No. 2022-102029, filed Jun. 24, 2022; the contents of both of which are hereby incorporated by reference in their entirety.

### BACKGROUND

### Technical Field

The present application generally relates to an energy storage apparatus including an energy storage device unit including an energy storage device.

### Description of Related Art

Conventionally, an energy storage apparatus including an energy storage device unit including an energy storage device and an external terminal is known. JP-A-2019-133861 discloses a battery pack (energy storage device unit, energy storage apparatus) including a secondary battery (energy storage device) and a high-voltage terminal (external terminal).

### BRIEF SUMMARY

In the conventional energy storage apparatus, vibration resistance or impact resistance may not be improved. That is, in the above-mentioned conventional energy storage apparatus, since a member for protecting the external terminal is not disposed, there is a possibility that the external terminal, a wiring connected to the external terminal, or the like is damaged by being brought into contact with another member by external vibration or impact.

Embodiments of the present invention have been made by the inventor of the present application in view of the above problems, and an object of embodiments of the present invention is to provide an energy storage apparatus capable of easily improving vibration resistance or impact resistance.

An energy storage apparatus according to one aspect of the present invention includes an energy storage device unit including an energy storage device and an external terminal, in which the external terminal is disposed on an end portion of the energy storage device unit in a first direction, the energy storage device unit further includes a side member disposed in a second direction with respect to the energy storage device, the second direction intersecting the first direction, and the side member includes a projecting portion projecting more than the external terminal in the first direction.

According to the energy storage apparatus of some embodiments of the present invention, vibration resistance or impact resistance can be easily improved.

### BRIEF DESCRIPTION OF THE FIGURES

FIG. 1 is a perspective view showing a configuration of an energy storage apparatus according to an embodiment.

FIG. 2 is a perspective view showing an internal configuration of an outer case of the energy storage apparatus according to the embodiment.

FIG. 3 is an exploded perspective view showing respective constituent elements when an energy storage unit included in the energy storage apparatus according to the embodiment is disassembled.

FIG. 4 is a perspective view showing a configuration of an energy storage device unit according to the embodiment.

FIG. 5 is a top view showing a positional relationship between the energy storage device unit and an inner case according to the embodiment.

FIG. 6 is a front view showing a positional relationship between the energy storage device unit and the inner case according to the embodiment.

### DETAILED DESCRIPTION OF VARIOUS EMBODIMENTS

(1) An energy storage apparatus according to one aspect of the present invention includes an energy storage device unit including an energy storage device and an external terminal, in which the external terminal is disposed on an end portion of the energy storage device unit in a first direction, the energy storage device unit further includes a side member disposed in a second direction with respect to the energy storage device, the second direction intersecting the first direction, and the side member includes a projecting portion projecting more than the external terminal in the first direction.

With such a configuration, in the energy storage apparatus, the side member of the energy storage device unit includes the projecting portion which projects more than the external terminal and hence, it is possible to suppress the occurrence of a phenomenon that the external terminal, the wiring connected to the external terminal, or the like are damaged by being brought into contact with other members by vibration or an impact from the outside. As a result, the external terminal, the wiring, and the like can be protected with a simple configuration and hence, vibration resistance or impact resistance of the energy storage apparatus can be easily improved.

(2) In the energy storage apparatus according to (1), the energy storage device unit may further include a cover member covering the external terminal, and the projecting portion may project more than the cover member in the first direction.

With such a configuration, the projecting portion of the side member projects more than the cover member covering the external terminal and hence, the external terminal can be protected together with the cover member.

(3) In the energy storage apparatus according to (1) or (2), the side member may include a recessed portion, and the recessed portion may be disposed in the first direction with respect to the projecting portion, or may be disposed in a third direction with respect to the projecting portion, the third direction intersecting the first direction and the second direction.

With such a configuration, the side member includes the recessed portion in the first direction with respect to the projecting portion or the third direction with respect to the projecting portion and hence, the wiring connected to the external terminal or the like can be disposed in the recessed portion.

(4) In the energy storage apparatus according to (3), the recessed portion may be disposed in the second direction with respect to the external terminal.

With such a configuration, the recessed portion of the side member is disposed on the side (the second direction) with respect to the external terminal and hence, it is possible to easily dispose the wiring connected to the external terminal or the like in the recessed portion.

(5) The energy storage apparatus according to (3) or (4) may further include a plurality of the energy storage device units, in which the plurality of energy storage device units may include a first energy storage device unit and a second energy storage device unit arrayed in the second direction, and the recessed portion included in the side member of the first energy storage device unit and the recessed portion included in the side member of the second energy storage device unit may be disposed adjacent to each other in the second direction.

With such a configuration, the plurality of energy storage device units includes the first energy storage device unit and the second energy storage device unit, and by arraying the recessed portion included in the side member of the first energy storage device unit and the recessed portion included in the side member of the second energy storage device unit at positions adjacent to each other, it is possible to dispose the wiring which connects the external terminals of the two energy storage device units through the two recessed portions or the like.

(6) The energy storage apparatus according to any one of (1) to (5) may further include a wall portion disposed in the first direction with respect to the projecting portion.

With such a configuration, the wall portion is disposed in the first direction of the projecting portion of the side member and hence, even when an impact is applied from the outside in the first direction, the wall portion is brought into contact with the projecting portion whereby the external terminal and the like can be protected.

Hereinafter, an energy storage apparatus according to an embodiment (and a modification example thereof) of the present invention is described with reference to the drawings. The embodiments described below show comprehensive or specific examples. However, numerical values, shapes, materials, constituent elements, array positions and connection modes of the constituent elements, manufacturing steps, order of manufacturing steps, and the like described in the following embodiments are only examples and are not intended to limit the present invention. In each drawing, dimensions and the like are not strictly shown. In the drawings, the same or similar constituent elements are denoted by the same reference numerals.

In the following description and drawings, an opposing direction of a pair of short side walls of a case (inner case) of an energy storage apparatus, an aligning direction of a pair of external terminals included in an energy storage device unit, an opposing direction of a pair of side members included in the energy storage device unit, an opposing direction of a long side surface of the energy storage device and a side member of the energy storage device unit, an aligning direction of an external terminal and a side member of the energy storage device unit, or an opposing direction of a pair of long side surfaces of the energy storage device is defined as an X-axis direction. An opposing direction of a pair of long side walls of a case (inner case) of the energy storage apparatus, a projecting direction of an external terminal of the energy storage device unit, an opposing direction of short side surfaces of the energy storage device, or an aligning direction of a pair of electrode terminals included in the energy storage device is defined as a Y-axis direction. An opposing direction of an upper wall and a bottom wall of a case (inner case) of the energy storage apparatus, an aligning direction of a body and a lid of a case of the energy storage device, a projecting direction of an electrode terminal of the energy storage device, or a vertical direction is defined as a Z-axis direction. These X-axis direction, Y-axis direction, and Z-axis direction are directions that intersect with each other (orthogonal in the present embodiment).

In the following description, the X-axis plus direction indicates an arrow direction of the X-axis, and the X-axis minus direction indicates the direction opposite to the X-axis plus direction. Simply referring to the X-axis direction refers to either or both of the X-axis plus direction and the X-axis minus direction. The same applies to the Y-axis direction and the Z-axis direction. Hereinafter, the Y-axis direction may also be referred to as a first direction, the X-axis direction may also be referred to as a second direction, and the Z-axis direction may also be referred to as a third direction. The X-axis direction may be described as the left-right direction. Expressions indicating relative directions or postures, such as parallel and orthogonal, strictly include also cases where the directions or postures are not the same. For example, the fact that two directions are parallel not only means that the two directions are completely parallel, but also means that they are substantially parallel, that is, that they include a difference of, for example, about several percent. In the following description, the expression “insulation” means “electrical insulation”.

### EMBODIMENT

### 1 General Description of Energy Storage Apparatus 10

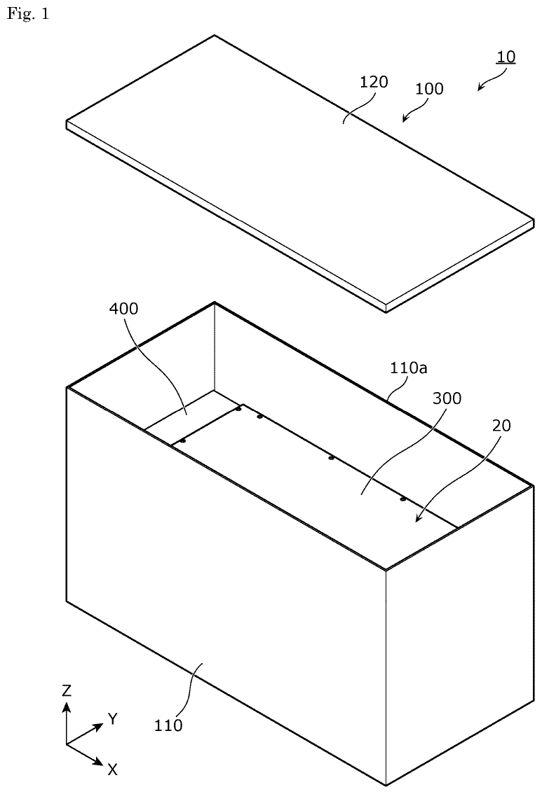

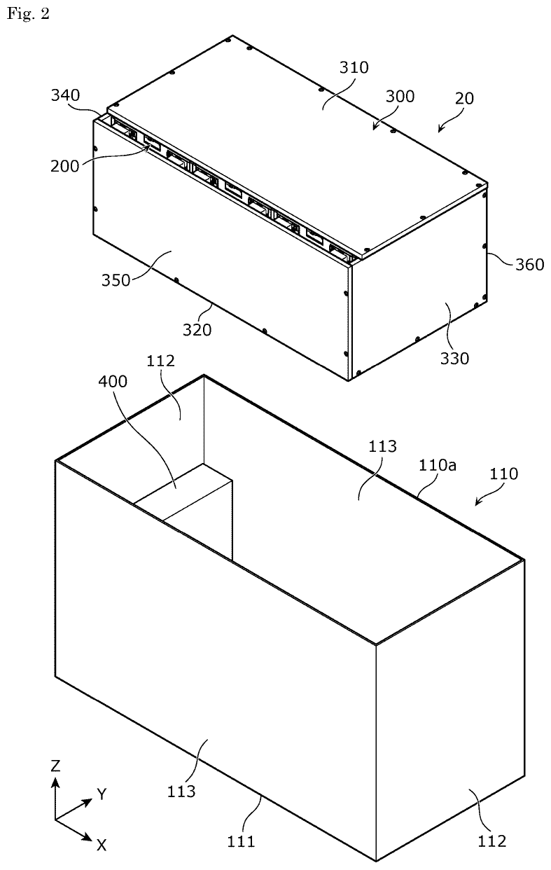

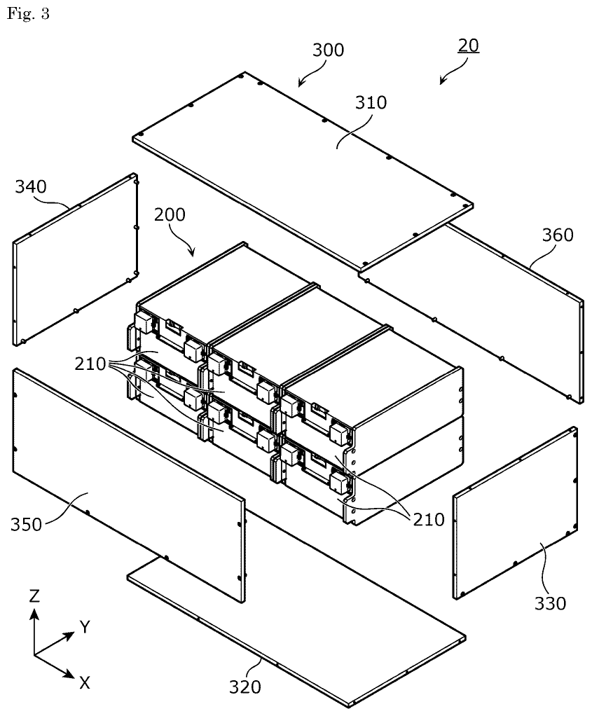

First, a general description of an energy storage apparatus 10 according to the present embodiment will be given. FIG. 1 is a perspective view showing a configuration of an energy storage apparatus 10 according to the present embodiment. FIG. 1 shows a state where the outer case lid body 120 is removed from the outer case body 110 of the outer case 100 included in the energy storage apparatus 10. FIG. 2 is a perspective view showing an internal configuration of the outer case 100 of the energy storage apparatus 10 according to the present embodiment. FIG. 2 shows a state where the energy storage unit 20 inside the outer case 100 of the energy storage apparatus 10 is taken out from the outer case body 110. FIG. 3 is an exploded perspective view showing respective constituent elements when the energy storage unit 20 included in the energy storage apparatus 10 according to the present embodiment is disassembled.

The energy storage apparatus 10 is an apparatus capable of charging electricity from the outside and discharging electricity to the outside, and has a rectangular parallelepiped shape in the present embodiment. The energy storage apparatus 10 is used for power storage, power supply, or the like. The energy storage apparatus 10 is used as a battery or the like for driving or starting an engine of a moving body such as an automobile, a motorcycle, a forklift, a watercraft, a ship, a snowmobile, an agricultural machine, a construction machine, or a railway vehicle for electric railway. Examples of the automobile include an electric vehicle (EV), a hybrid electric vehicle (HEV), a plug-in hybrid electric vehicle (PHEV), and a fossil fuel (Gasoline, light oil, liquefied natural gas, etc.) automobile. Examples of the railway vehicle for an electric railway include a train, a monorail, a linear motor car, and a hybrid train including both a diesel engine and an electric motor. The energy storage apparatus 10 can also be used as a stationary battery or the like used for home use, business use, or the like.

As shown in FIG. 1 to FIG. 3, the energy storage apparatus 10 includes an outer case 100, an energy storage unit 20, and a weight 400. The energy storage unit 20 includes an energy storage device unit group 200 including a plurality of energy storage device units 210, and an inner case 300. In addition to the above configuration, the energy storage apparatus 10 also includes a total terminal of positive and negative electrodes of the energy storage apparatus 10, a conductive member (wiring, bus bar, etc.) that connects the energy storage device units 210 to each other or connects the energy storage device unit 210 and the total terminal, a circuit board that monitors or controls a state (voltage, temperature, charge-discharge state, and the like) of the energy storage device unit 210, and electric components such as a relay, a fuse, a shunt resistor, and a connector, but illustration and detailed description thereof are omitted.

The outer case 100 is a rectangular parallelepiped (box-shaped) case (outer box) configuring a case (outer case, housing, outer shell) outside the energy storage apparatus 10. The outer case 100 is disposed outward the energy storage unit 20 (energy storage device unit group 200, inner case 300), the weight 400, and the like, houses them at predetermined positions, and protects them from impact or the like. The outer case 100 is a metal case formed of a metal member such as aluminum, an aluminum alloy, stainless steel, iron, or a plated steel plate. The outer case 100 may be formed of a member having an insulating property such as any resin material which can be used for a cover member 216 of the energy storage device unit 210 described later.

As illustrated in FIG. 1, the outer case 100 includes an outer case body 110 configuring a body of the outer case 100 and an outer case lid body 120 configuring a lid body of the outer case 100. The outer case body 110 is a bottomed rectangular cylindrical housing opened in the Z-axis plus direction, and houses and fixes the energy storage unit 20 (energy storage device unit group 200, inner case 300), the weight 400, and the like at a predetermined position.

Specifically, as illustrated in FIG. 2, a rectangular opening 110a is formed in the outer case body 110 in the Z-axis plus direction. The outer case body 110 includes an outer case bottom wall 111 having a flat plate shape and a rectangular shape and disposed in the Z-axis minus direction. The outer case body 110 includes a pair of outer case side walls 112 that are flat plate-shaped and rectangular short side walls on both sides in the X-axis direction, and a pair of outer case side walls 113 that are flat plate-shaped and rectangular long side walls on both sides in the Y-axis direction. The outer case side wall 112 is a wall opposed to (orthogonal to) the X-axis direction, and is disposed at an end portion of the outer case body 110 in the X-axis direction. The outer case side wall 113 is a wall opposed to (orthogonal to) the Y-axis direction, and is disposed at an end portion of the outer case body 110 in the Y-axis direction.

The outer case lid body 120 is a plate-like and rectangular lid that closes the opening 110a of the outer case body 110. The outer case body 110 and the outer case lid body 120 are joined to each other by screwing or the like with bolts. As a result, the outer case 100 has a structure in which the inside is sealed (sealed). The outer case body 110 and the outer case lid body 120 may be joined by welding, bonding, or the like. The outer case body 110 and the outer case lid body 120 may be made of the same material or different materials. The outer case body 110 (outer case bottom wall 111, outer case side walls 112, 113) and the outer case lid body 120 may have any shape depending on the configuration (number, size, shape, and the like) of the contents of the outer case 100. In this case, the outer case side wall 112 may be a long side wall, and the outer case side wall 113 may be a short side wall.

As shown in FIG. 3, the energy storage device unit group 200 includes a plurality of energy storage device units 210. In the present embodiment, the energy storage device unit group 200 includes six energy storage device units 210 in which three energy storage device units 210 arrayed in the X-axis direction are arrayed in two stages in the Z-axis direction. The number of the energy storage device units 210 included in the energy storage device unit group 200 is not particularly limited, and any number of energy storage device units 210 may be arrayed in the Z-axis direction, any number of energy storage device units 210 may be arrayed in the X-axis direction, or a plurality of energy storage device units 210 may be arrayed also in the Y-axis direction. The energy storage device unit group 200 may include only one energy storage device unit 210. In the present embodiment, all the energy storage device units 210 are connected in series, but any of the energy storage device units 210 may be connected in parallel. The configuration of the energy storage device unit 210 will be described in detail later.

The inner case 300 is a case for housing the energy storage device unit 210. The inner case 300 is a case (inner box) having a substantially rectangular parallelepiped shape (box shape) configuring a case (housing) inside the energy storage apparatus 10. The inner case 300 is disposed outward the energy storage device unit group 200, houses and holds the energy storage device unit group 200 (energy storage device unit 210), and protects the energy storage device unit group from an impact or the like. The inner case 300 is a metal case formed of a metal member such as aluminum, an aluminum alloy, stainless steel, iron, or a plated steel plate. In the present embodiment, the inner case 300 is formed of a member having the same material as the outer case 100, but may be formed of a member having the material different from the material of the outer case 100. The inner case 300 may be formed of a member having an insulating property such as any resin material which can be used for a cover member 216 of the energy storage device unit 210 described later. In the present embodiment, the inner case 300 is a case for housing the energy storage device unit 210, and the outer case 100 is a case for housing the inner case 300.

As illustrated in FIGS. 2 and 3, the inner case 300 includes an inner case upper wall 310 configuring an upper wall of the inner case 300, an inner case bottom wall 320 configuring a bottom wall of the inner case 300, and inner case side walls 330 to 360 configuring four side walls of the inner case 300. In the present embodiment, the inner case upper wall 310, the inner case bottom wall 320, and the inner case side walls 330 to 360 are all configured separately. That is, the inner case 300 includes six walls configured separately from each other.

The inner case upper wall 310 is a flat plate-like rectangular upper wall which is disposed in the Z-axis plus direction of the energy storage device unit group 200 and is parallel to the XY plane (opposed to (orthogonal to) the Z-axis direction). The inner case upper wall 310 is disposed between the energy storage device unit group 200 and the outer case lid body 120 in the Z-axis direction. The inner case upper wall 310 is joined to end portions of the inner case side walls 330, 340, and 360 in the Z-axis plus direction by screwing or the like with bolts. In the present embodiment, the inner case upper wall 310 is disposed in the Z-axis plus direction of the inner case side walls 330, 340, and 360, and is joined to the end portions of the inner case side walls 330, 340, and 360 in the Z-axis plus direction in the Z-axis direction. Electric components such as a circuit board, a relay, a fuse, a shunt resistor, and a connector which monitor or control a state (voltage, temperature, charge-discharge state, and the like) of the energy storage device unit 210 may be disposed on the inner case upper wall 310.

The inner case bottom wall 320 is a flat plate-like rectangular bottom wall which is disposed in the Z-axis minus direction of the energy storage device unit group 200 and is parallel to the XY plane (opposed to (orthogonal to) the Z-axis direction). The inner case bottom wall 320 is disposed between the energy storage device unit group 200 and the outer case bottom wall 111 in the Z-axis direction. The inner case bottom wall 320 is joined to end portions of the inner case side walls 330 to 360 in the Z-axis minus direction by screwing or the like with a bolt. In the present embodiment, the inner case bottom wall 320 is disposed between the inner case side walls 330, 340 in the X-axis direction, and is joined to end portions of the inner case side walls 330, 340 in the Z-axis minus direction in the X-axis direction. The inner case bottom wall 320 is disposed between the inner case side walls 350 and 360 in the Y-axis direction, and is joined to the end portions of the inner case side walls 350 and 360 in the Z-axis minus direction in the Y-axis direction.

The inner case bottom wall 320 may be joined (fixed) to the outer case bottom wall 111 by bonding using an adhesive, double-sided tape, or the like, welding, welding, bolt joining, caulked joining, or the like. A plate-like member such as a rubber plate or a resin member for tolerance absorption or vibration suppression (anti-slip), or another member such as a weight may be disposed between the inner case bottom wall 320 and the outer case bottom wall 111.

The inner case side walls 330 and 340 are flat plate-shaped and rectangular short side walls which are disposed on both sides of the energy storage device unit group 200 in the X-axis direction and are parallel to the YZ plane (opposed to (orthogonal to) the X-axis direction). The inner case side wall 330 is disposed in the X-axis plus direction of the energy storage device unit group 200, and the inner case side wall 340 is disposed in the X-axis minus direction of the energy storage device unit group 200. The inner case side walls 330 and 340 are disposed between the energy storage device unit group 200 and the outer case side wall 112 (between the energy storage device unit group 200 and the weight 400) in the X-axis direction. The inner case side walls 330 and 340 are joined to end portions of the inner case upper wall 310, the inner case bottom wall 320, and the inner case side walls 350 and 360 in the X-axis direction by screwing or the like with bolts. In the present embodiment, the inner case side walls 330 and 340 are disposed outside the inner case bottom wall 320 and the inner case side wall 360 in the X-axis direction, and are joined to both end portions of the inner case bottom wall 320 and the inner case side wall 360 in the X-axis direction.

The inner case side walls 350 and 360 are flat plate-shaped and rectangular long side walls which are disposed on both sides of the energy storage device unit group 200 in the Y-axis direction and are parallel to the XZ plane (opposed to (orthogonal to) the Y-axis direction). The inner case side wall 350 is disposed in the Y-axis minus direction of the energy storage device unit group 200, and the inner case side wall 360 is disposed in the Y-axis plus direction of the energy storage device unit group 200. The inner case side walls 350 and 360 are disposed between the energy storage device unit group 200 and the outer case side wall 113 in the Y-axis direction. The inner case side wall 350 is joined to end portions of the inner case bottom wall 320 and the inner case side walls 330 and 340 in the Y-axis minus direction by screwing or the like with bolts. In the present embodiment, the inner case side wall 350 is disposed in the Y-axis minus direction of the inner case bottom wall 320 and the inner case side walls 330 and 340, and is joined to end portions in the Y-axis minus direction of the inner case bottom wall 320 and the inner case side walls 330 and 340 in the Y-axis direction. The inner case side wall 360 is joined to end portions of the inner case upper wall 310, the inner case bottom wall 320, and the inner case side walls 330 and 340 in the Y-axis plus direction by screwing or the like with bolts. In the present embodiment, the inner case side wall 360 is disposed in the Y-axis plus direction of the inner case bottom wall 320, and is joined to the end portion of the inner case bottom wall 320 in the Y-axis plus direction in the Y-axis direction.

The inner case 300 restricts the movement of the energy storage device unit group 200 by at least one wall of the inner case upper wall 310, the inner case bottom wall 320, and the inner case side walls 330 to 360 coming into contact with the energy storage device unit group 200. In this embodiment, all walls of the inner case upper wall 310, the inner case bottom wall 320, and the inner case side walls 330 to 360 are brought into contact with the energy storage device unit group 200. At least one wall of the inner case upper wall 310, the inner case bottom wall 320, and the inner case side walls 330 to 360 includes, on its inner surface, a plate-like member such as a rubber plate or a resin member for tolerance absorption or vibration suppression (anti-slip), and the plate-like member or the like may come into contact with the energy storage device unit group 200.

The walls of the inner case upper wall 310, the inner case bottom wall 320, and the inner case side walls 330 to 360 may be joined to each other by welding, bonding, or the like. All of the inner case upper wall 310, the inner case bottom wall 320, and the inner case side walls 330 to 360 may be made of a member having the same material, or any of the walls may be made of members having different materials. The inner case upper wall 310, the inner case bottom wall 320, and the inner case side walls 330 to 360 may have any shape depending on the size, shape, and the like of the energy storage device unit group 200. In this case, the inner case side walls 330 and 340 may be long side walls, and the inner case side walls 350 and 360 may be short side walls.

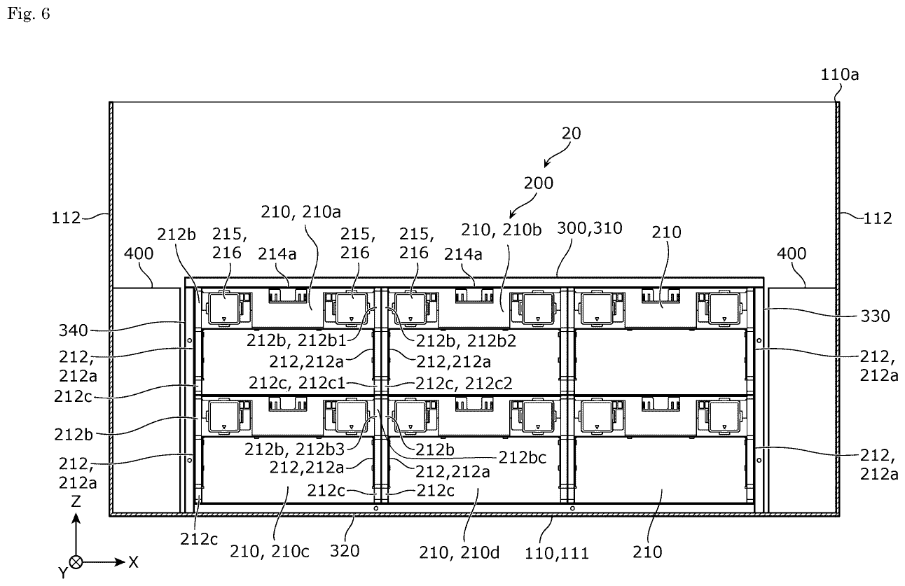

The weight 400 is a weight disposed inside the outer case 100 and outward the inner case 300. The weight 400 is a weight (counter weight) for adjusting the weight of the energy storage apparatus 10. In the present embodiment, the weight 400 has a rectangular parallelepiped shape that is flat in the X-axis direction. The weight 400 faces the outer case side wall 112 of the outer case body 110 of the outer case 100 and is disposed in contact with the outer case side wall 112. In the present embodiment, the weight 400 is joined (fixed) to the outer case side wall 112 by welding (spot welding or the like) or the like. The weight 400 may be joined (fixed) to the outer case side wall 112 by bonding using an adhesive, double-sided tape, or the like, welding, bolt joining, caulked joining, or the like. In the present embodiment, two weights 400 are disposed on both sides in the X-axis direction of the energy storage unit 20 (energy storage device unit group 200, inner case 300) (see FIG. 6). Specifically, two weights 400 are disposed between the inner case side wall 330 and the outer case side wall 112 in the X-axis plus direction and between the inner case side wall 340 and the outer case side wall 112 in the X-axis minus direction.

As the weight of the weight 400, the weight necessary for adjusting the weight of the energy storage apparatus 10 is appropriately determined, but in the present embodiment, the weight of one weight 400 is about 50 to 60 kg. The total weight of all (In the present embodiment, two) weights 400 provided in the energy storage apparatus 10 is preferably ⅕ or more, more preferably ¼ or more, and still more preferably ⅓ or more of the total weight of the energy storage apparatus 10. The material of the weight 400 is not particularly limited, but can be formed of any metal member that can be used for the outer case 100 and the inner case 300, such as aluminum, an aluminum alloy, stainless steel, or iron. In the present embodiment, the two weights 400 are formed of a member having the same material as the outer case 100 and the inner case 300, but may be formed of members having materials different from the outer case 100 and the inner case 300, or the two weights 400 may be formed of members having materials different from each other.

### 2 Description of Energy Storage Device Unit 210

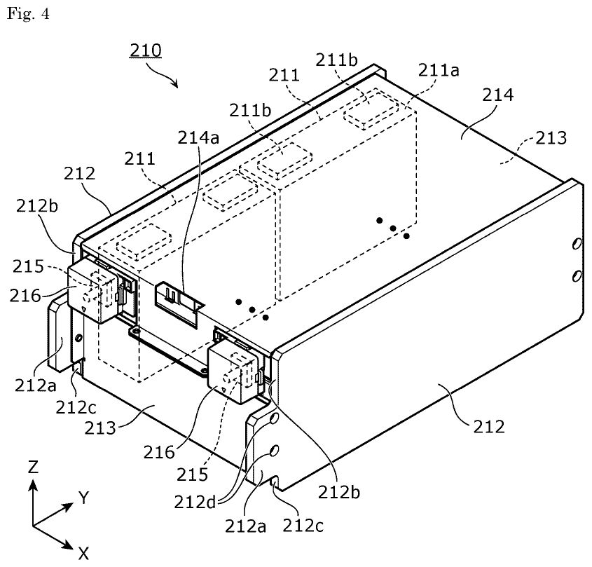

Next, the configuration of the energy storage device unit 210 is described in detail. FIG. 4 is a perspective view showing a configuration of the energy storage device unit 210 according to the present embodiment. FIG. 4 is an enlarged view of one energy storage device unit 210 shown in FIG. 3, and the energy storage devices 211 located therein and the external terminal 215 are shown by broken lines. Since all of the plurality of energy storage device units 210 included in the energy storage apparatus 10 (energy storage unit 20, energy storage device unit group 200) have the same configuration, FIG. 4 shows one energy storage device unit 210, and hereinafter, the configuration of one energy storage device unit 210 will be described in detail.

The energy storage device unit 210 is a battery module (assembled battery) having a substantially rectangular parallelepiped shape capable of charging electricity from the outside and discharging electricity to the outside. As shown in FIG. 4, the energy storage device unit 210 includes a plurality of energy storage devices 211, a pair of end plates 212, a pair of side plates 213, a cover member 214, a pair of (positive electrode and negative electrode) external terminals 215, and a pair of (positive electrode and negative electrode) cover members 216. In addition to the above-mentioned configuration, the energy storage device unit 210 also includes a spacer disposed between the energy storage devices 211, a bus bar which connects the electrode terminals 211b of the plurality of energy storage devices 211 to each other, a bus bar frame which positions the bus bar and the like, but the illustration and the detailed description thereof are omitted.

The energy storage device 211 is a secondary battery (battery cell) capable of charging and discharging electricity, and more specifically, is a nonaqueous electrolyte secondary battery such as a lithium ion secondary battery. In the present embodiment, the plurality of energy storage devices 211 are arrayed side by side in the X-axis direction and the Y-axis direction, but the aligning direction and the number of energy storage devices 211 are not particularly limited, and only one energy storage device 211 may be arrayed. In the present embodiment, when the energy storage device 211 is disposed such that the direction in which the pair of electrode terminals 211b are arrayed is the Y-axis direction, the energy storage device 211 has a rectangular parallelepiped shape (prismatic) which is flat in the X-axis direction, and has a long side surface and a short side surface. In the energy storage device 211, the X-axis direction is a thickness direction of the energy storage device 211. The shape of the energy storage device 211 is not limited to the rectangular parallelepiped shape, and may be a polygonal columnar shape, a cylindrical shape, a long cylindrical shape, an elliptic columnar shape or the like other than the rectangular parallelepiped shape. The energy storage device 211 is not limited to the nonaqueous electrolyte secondary battery, and may be a secondary battery other than the nonaqueous electrolyte secondary battery, or may be a capacitor. The energy storage device 211 may be not a secondary battery but a primary battery that can use stored electricity without being charged by a user. The energy storage device 211 may be a battery using a solid electrolyte. The energy storage device 211 may be a pouch type energy storage device.

The energy storage device 211 includes a case 211a having a long side surface and a short side surface, and a pair of (positive electrode and negative electrode) electrode terminals 211b. An electrode assembly, a pair of (positive electrode and negative electrode) current collectors, an electrolyte solution (nonaqueous electrolyte), and the like are housed in the case 211a, but illustration and detailed description thereof are omitted. The case 211a includes a case main body in which an opening is formed, and a lid portion which closes the opening of the case main body, and the electrode terminal 211b is arrayed in a state of protruding from the lid portion in the Z-axis plus direction. The electrode terminal 211b is electrically connected to the positive electrode plate and the negative electrode plate of the electrode assembly via a conductive current collector. The electrode assembly is an energy storage element (power generating element) formed by stacking a positive electrode plate, a negative electrode plate, and a separator.

The end plates are members disposed at both ends of the array when the plurality of energy storage devices is arrayed such that long side surfaces of the respective energy storage devices are opposed to each other. The side plates are members connected to the end plates at both ends. The pair of end plates 212 sandwich the plurality of energy storage devices 211 from both sides in the aligning direction (X-axis direction) when the plurality of energy storage devices is disposed such that long side surfaces of the respective energy storage devices 211 face each other. The pair of end plates 212 are restraining members which compress (restrain) the plurality of energy storage devices 211 from both sides in the aligning direction (X-axis direction). The pair of side plates 213 are connected to a pair of end plates for restraining the plurality of energy storage devices 211. The end plate 212 and the side plate 213 are formed of a metal member such as steel or stainless steel from the viewpoint of securing strength and the like, but the material thereof is not particularly limited, and may be formed of an insulating member having high strength, or an insulation treatment may be applied to the metal member.

The end plate 212 is a plate-like and rectangular member disposed in the X-axis direction (second direction intersecting the first direction) of the energy storage device 211. The pair of end plates 212 are disposed on both sides in the X-axis direction of the plurality of energy storage devices 211, and sandwich and hold the plurality of energy storage devices 211 from both sides in the X-axis direction. The end plate 212 may be a flat block-shaped member or the like instead of a plate-like member. The end plate 212 is an example of a “side member” disposed on a side (second direction) of the energy storage device 211.

The end plate 212 (side member) includes a projecting portion 212a projecting in the Y-axis direction (first direction) and recessed portions 212b and 212c disposed in the Z-axis direction (third direction intersecting the first direction and the second direction) of the projecting portion 212a. In the present embodiment, both of the pair of end plates 212 include projecting portions 212a and recessed portions 212b and 212c having the same configuration.

The projecting portion 212a is a flat plate-shaped and rectangular portion extending in the Z-axis direction and projecting in the Y-axis minus direction from a substantially central portion in the Z-axis direction at the end portion in the Y-axis minus direction of the end plate 212. The projecting portion 212a is provided with a fixing portion 212d for fixing the end plate 212 to the side plate 213. In the present embodiment, the fixing portion 212d is a through hole into which a fixing member (not shown) such as a bolt is inserted, and two fixing portions 212d aligned in the Z-axis direction are disposed at a root (end portion in the Y-axis plus direction) of the projecting portion 212a. Accordingly, the end plate 212 is fixed to the side plate 213 at the projecting portion 212a.

The recessed portions 212b and 212c are recessed portions which are disposed on both sides of the projecting portion 212a in the Z-axis direction so as to sandwich the projecting portion 212a therebetween in the Z-axis direction, and are recessed from the projecting portion 212a in the Y-axis direction and the Z-axis direction. In the present embodiment, the recessed portions 212b and 212c are notches formed at the end portion in the Y-axis minus direction of the end plate 212 and at the corner portions of both end portions in the Z-axis direction.

Specifically, the recessed portion 212b is a recessed portion which is disposed in the Z-axis plus direction of the projecting portion 212a and is recessed from the projecting portion 212a in the Y-axis plus direction as viewed in the X-axis direction. The recessed portion 212b is also a recessed portion recessed from the projecting portion 212a in the Z-axis minus direction. The recessed portion 212b is a rectangular recessed portion in which corner portions of the end portion in the Y-axis minus direction and the end portion in the Z-axis plus direction of the rectangular end plate 212 (not illustrated) are recessed in the Y-axis plus direction and the Z-axis minus direction. The recessed portion 212b is a rectangular notch in which corner portions of the end portion in the Y-axis minus direction and the end portion in the Z-axis plus direction of the rectangular end plate 212 are cut out in the Y-axis plus direction and the Z-axis minus direction. The recessed portion 212b is disposed in the X-axis direction (second direction) of the external terminal 215. That is, in the end plate 212 in the X-axis plus direction, the recessed portion 212b is disposed adjacent to the external terminal 215 in the X-axis plus direction. In the end plate 212 in the X axis minus direction, the recessed portions 212b are disposed adjacent to each other in the X axis minus direction of the external terminal 215 in the X axis minus direction. As a result, the external terminal 215 is disposed such that at least a part of the external terminal projects from the recessed portion 212b as viewed in the X-axis direction.

The recessed portion 212c is a recessed portion that is disposed in the Z-axis minus direction of the projecting portion 212a and is recessed from the projecting portion 212a in the Y-axis plus direction as viewed in the X-axis direction. The recessed portion 212c is also a recessed portion recessed from the projecting portion 212a in the Z-axis plus direction. The recessed portion 212c is a rectangular recessed portion in which corner portions of the end portion in the Y-axis minus direction and the end portion in the Z-axis minus direction of the rectangular end plate 212 (not illustrated) are recessed in the Y-axis plus direction and the Z-axis plus direction. The recessed portion 212c is a rectangular notch in which corner portions of the end portion in the Y-axis minus direction and the end portion in the Z-axis minus direction of the rectangular end plate 212 (not shown) are cut out in the Y-axis plus direction and the Z-axis plus direction. The shape and size of the recessed portion 212c are not particularly limited, but in the present embodiment, the length (depth) of the recessed portion 212c in the Y-axis direction is the same as that of the recessed portion 212b, and the length (width) in the Z-axis direction is shorter than that of the recessed portion 212b. That is, the projecting portion 212a is disposed at a position shifted in the Z-axis minus direction from the center position in the Z-axis direction at the end portion in the Y-axis minus direction of the end plate 212. In the present embodiment, a total length of the recessed portions 212b and 212c in the Z-axis direction is substantially equal to a length of the projecting portion 212a. A more detailed description of the configuration of the end plate 212 (side member) will be given later.

The side plate 213 is a plate-like and rectangular member disposed in the Y-axis direction of the energy storage device 211. That is, the pair of side plates 213 are disposed on both sides of the plurality of energy storage devices 211 in the Y-axis direction. Both end portions of the side plate 213 in the X axis direction are attached to end portions of the pair of end plates 212 in the Y-axis direction, and the pair of end plates 212 are connected to each other, thereby restraining the plurality of energy storage devices 211. That is, the side plate 213 extends in the X-axis direction so as to straddle the plurality of energy storage devices 211, and applies a restraining force in the X-axis direction to the plurality of energy storage devices 211. In the present embodiment, the side plate 213 is joined (fixed) to the end plate 212 (the fixing portion 212d of the projecting portion 212a) by a fixing member (not illustrated) such as a bolt and a nut. The side plate 213 may be joined (fixed) to the end plate 212 by welding, bonding, or the like. The side plate 213 may be a long rod-shaped member or the like instead of a plate-like member.

The cover member 214 is a member that covers the plurality of energy storage devices 211 and the like in the Z-axis plus direction, and protects the plurality of energy storage devices 211 and the like from external impact or the like. The cover member 214 is attached and fixed to the pair of side plates 213. In the present embodiment, the cover member 214 is a metal member, but may be a resin member. An opening 214a through which wiring or the like for monitoring or controlling a state (voltage, temperature, charge-discharge state, and the like) of the energy storage device 211 passes is formed at a center portion in the X-axis direction at an end portion in the Y-axis minus direction of the cover member 214.

The external terminal 215 is an external terminal which is electrically connected to the electrode terminal 211b of the energy storage device 211, charges electricity from the outside, and discharges electricity to the outside. That is, the external terminal 215 is a terminal member different from the electrode terminal 211b of the energy storage device 211. The external terminal 215 is formed of a conductive member made of metal such as aluminum, an aluminum alloy, copper, a copper alloy, or nickel, a combination thereof, or a conductive member other than metal. The external terminal 215 is disposed at an end portion of the energy storage device unit 210 in the Y-axis direction (first direction). In the present embodiment, a pair of (positive electrode and negative electrode) external terminals 215 arrayed in the X-axis direction are disposed at the end portion in the Z-axis plus direction and at both end portions in the X-axis direction at the end portion in the Y-axis minus direction of the energy storage device unit 210. The external terminals 215 are arrayed in a state of protruding in the Y-axis minus direction from a body portion (a portion where the energy storage devices 211 are arrayed) of the energy storage device unit 210. Specifically, the external terminal 215 protrudes in the Y-axis minus direction from a surface of the side plate 213 in the Y-axis minus direction and a surface of the cover member 214 in the Y-axis minus direction.

The cover member 216 is a cover member of the external terminal 215 disposed so as to cover the external terminal 215. The cover member 216 is formed of an insulating member such as polycarbonate (PC), polypropylene (PP), polyethylene (PE), polystyrene (PS), a polyphenylene sulfide resin (PPS), polyphenylene ether (PPE (including modified PPE)), polyethylene terephthalate (PET), polybutylene terephthalate (PBT), polyether ether ketone (PEEK), tetrafluoroethylene-perfluoroalkyl vinyl ether (PFA), polytetrafluoroethylene (PTFE), polyether sulfone (PES), polyamide (PA), an ABS resin, or a composite material thereof, or an insulation-coated metal or the like. The cover member 216 thus protects the external terminal 215, and prevents the external terminal 215 from coming into contact with an external metal member or the like.

### 3 Description of Configuration of End Plate 212 (Side Member)

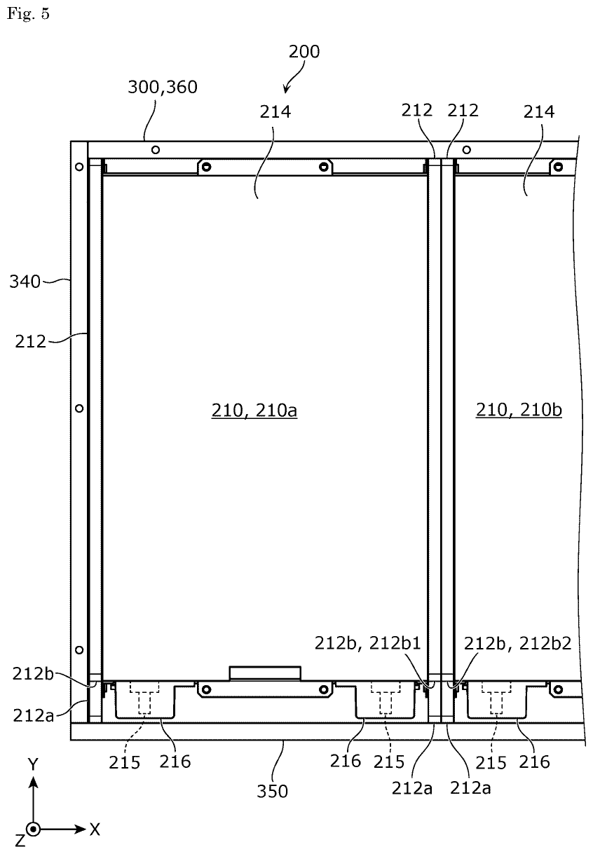

Next, the configuration of the end plate 212 (side member) of the energy storage device unit 210 will be described in more detail. FIG. 5 is a top view showing a positional relationship between the energy storage device unit 210 and the inner case 300 according to the present embodiment. FIG. 5 is a view illustrating a configuration where the inner case upper wall 310 is removed for convenience of description from a state where the energy storage device unit 210 is housed in the inner case 300 when the configuration is viewed from the Z-axis plus direction. FIG. 6 is a front view showing a positional relationship between the energy storage device unit 210 and the inner case 300 according to the present embodiment. FIG. 6 is a view showing a configuration where the outer case side wall 113 and the inner case side wall 350 in the Y-axis minus direction are removed for convenience of description from a state where the energy storage unit 20 (energy storage device unit group 200, the inner case 300) and the weight 400 are housed in the outer case body 110 as viewed from the Y-axis minus direction.

As shown in FIG. 5, in the energy storage device unit 210, the projecting portion 212a of the end plate 212 projects more, in the Y-axis direction (first direction), than the external terminal 215. The projecting portion 212a projects more, in the Y-axis direction (first direction), than the cover member 216. That is, the projecting portion 212a projects more, in the Y-axis minus direction, than the external terminal 215, and projects more, in the Y-axis minus direction, than the cover member 216. The inner case side wall 350 is disposed in the Y-axis minus direction of the projecting portion 212a, and the projecting portion 212a is brought into contact with the inner case side wall 350. That is, the external terminal 215 and the cover member 216 are disposed apart from the inner case side wall 350 without contacting the inner case side wall 350. The inner case side wall 350 is an example of a “wall portion” disposed in the Y-axis direction (first direction) of the projecting portion 212a.

The end plate 212 also contacts the inner case side wall 360 at the end portion in the Y-axis plus direction. As shown in FIG. 5 and FIG. 6, the end plates 212 located at both end portions of the energy storage device unit group 200 in the X-axis direction are brought into contact with the inner case side walls 330 and 340. Specifically, the end plate 212 in the X-axis plus direction of the energy storage device unit 210 which is positioned at the end portion in the X-axis plus direction is brought into contact with the inner case side wall 330. The end plate 212 in the X-axis minus direction of the energy storage device unit 210 which is positioned at the end portion in the X axis minus direction is brought into contact with the inner case side wall 340. As described above, in the energy storage device unit group 200, any of the end plates 212 is brought into contact with the inner surface of the inner case 300 on both sides in the X-axis direction and both sides in the Y-axis direction. As described above, when the inner case side walls 330 to 360 include the plate-shaped member on the inner surface, the end plate 212 comes into contact with the plate-shaped member.

The two energy storage device units 210 disposed adjacently to each other in the X-axis direction are disposed in a state where the end plates 212 which are opposed to each other in the X-axis direction are brought into contact with each other (overlap each other in the X-axis direction). Similarly, the two energy storage device units 210 disposed adjacently to each other in the Z-axis direction are disposed in a state where the end plates 212 which are opposed to each other in the Z-axis direction are brought into contact with each other (overlap each other in the Z-axis direction). When another member is sandwiched between the end plates 212, the end plates 212 are indirectly brought into contact with each other via the another member.

Two energy storage device units 210 adjacent to each other in the X-axis direction will be described as a first energy storage device unit 210a and a second energy storage device unit 210b. Two energy storage device units 210 adjacent to each other in the Z-axis direction will be described as a first energy storage device unit 210a and a third energy storage device unit 210c. In FIG. 6, the energy storage device unit 210 in the upper stage of the left row is referred to as a first energy storage device unit 210a. The energy storage device unit 210 in the upper stage of the center row is referred to as a second energy storage device unit 210b. The energy storage device unit 210 in the lower stage of the left row is referred to as a third energy storage device unit 210c. The energy storage device unit 210 in the lower stage of the center row is referred to as a fourth energy storage device unit 210d.

As shown in FIG. 6, the first energy storage device unit 210a and the second energy storage device unit 210b are arrayed side by side in the X-axis direction (second direction). The end plate 212 (side member) of the first energy storage device unit 210a and the end plate 212 (side member) of the second energy storage device unit 210b are disposed adjacently to each other in the X-axis direction (second direction). Accordingly, the projecting portion 212a of the end plate 212 (side member) of the first energy storage device unit 210a and the projecting portion 212a of the end plate 212 of the second energy storage device unit 210b are disposed adjacently to each other in the X-axis direction. The recessed portion 212b1 of the end plate 212 (side member) of the first energy storage device unit 210a and the recessed portion 212b2 of the end plate 212 of the second energy storage device unit 210b are disposed adjacent to each other in the X-axis direction. The recessed portion 212c1 of the end plate 212 (side member) of the first energy storage device unit 210a and the recessed portion 212c2 of the end plate 212 of the second energy storage device unit 210b are disposed adjacent to each other in the X-axis direction.

As shown in FIG. 6, the first energy storage device unit 210a and the third energy storage device unit 210c are arrayed side by side in the Z-axis direction (third direction). The end plate 212 (side member) of the first energy storage device unit 210a and the end plate 212 (side member) of the third energy storage device unit 210c are disposed adjacently to each other in the Z-axis direction (third direction). With such a configuration, the recessed portion 212c1 of the end plate 212 of the first energy storage device unit 210a disposed in the Z-axis plus direction and the recessed portion 212b3 of the end plate 212 of the third energy storage device unit 210c disposed in the Z-axis minus direction are connected to each other and hence, a larger recessed portion 212bc is formed. The same applies to the configuration in which the recessed portions 212b and 212c of the third energy storage device unit 210c in the lower stage of the left row and the recessed portions 212b and 212c of the fourth energy storage device unit 210d in the lower stage of the center row in FIG. 6 are adjacent to each other in the X-axis direction. The same applies to the configuration in which the recessed portion 212c of the second energy storage device unit 210b in the upper stage of the center row and the recessed portion 212b of the fourth energy storage device unit 210d in the lower stage of the center row in FIG. 6 are adjacent to each other in the Z-axis direction. The recessed portion 212b may be referred to as a first recessed portion, the recessed portion 212c may be referred to as a second recessed portion, and the recessed portion 212bc may be referred to as a third recessed portion. The third recessed portion is a recessed portion in which the first recessed portion and the second recessed portion are connected in the Z-axis direction.

With such a configuration, between the external terminals 215, 215 of the different energy storage device units 210 adjacent to each other in the X-axis direction, the recessed portion 212b of one energy storage device unit 210 and the recessed portion 212b of the other energy storage device unit 210 are arrayed adjacent to each other in the X-axis direction. Between the end portions in the Z-axis minus direction of the two energy storage device units 210 adjacent to each other in the X-axis direction, the recessed portion 212c of one energy storage device unit 210 and the recessed portion 212c of the other energy storage device unit 210 are disposed adjacent to each other in the X-axis direction. In these recessed portions, wiring connected to the external terminals 215 (main circuit wiring connecting two adjacent external terminals 215), control wiring led out from the opening 214a of the cover member 214, or the like is disposed. The recessed portion 212b and the recessed portion 212c are formed in a size through which the wiring and the like can pass. In the recessed portion 212bc where the recessed portion 212b and the recessed portion 212c are connected in the Z-axis direction, the recessed portion is enlarged in the Z-axis direction, so that the number of wiring paths can be increased. The wiring can be disposed obliquely with respect to the X-axis direction or the Z-axis direction via the recessed portion 212bc. Since the projecting portion 212a is disposed, a space in which the wiring and the like can be disposed is formed in the Y-axis minus direction of the energy storage device unit 210. With such a configuration, in the Y-axis minus direction of the energy storage device unit group 200, the wiring and the like can be disposed across the plurality of energy storage device units 210 in the X-axis direction and the Z-axis direction.

In the present embodiment, gaps are formed between the inner case side walls 330, 340 and the weight 400 in a state where the energy storage unit 20 is inserted into the outer case body 110, but the gaps may not be formed. Although gaps are also formed between the inner case side walls 350, 360 and the outer case side wall 113 of the outer case body 110, the gaps may not be formed. When the gap is formed, the insertion work becomes easy when the energy storage unit 20 is inserted into the outer case body 110, and the workability can be improved. When no gap is formed, space use efficiency in the energy storage apparatus 10 can be enhanced.

### 4 Description of Effects

As has been described heretofore, according to the energy storage apparatus 10 of the embodiment of the present invention, the end plate 212 (side member) of the energy storage device unit 210 includes the projecting portion 212a which projects more than the external terminal 215. As a result, it is possible to suppress the external terminal 215 and the wiring or the like connected to the external terminal 215 from coming into contact with other members and being damaged by vibration or impact from the outside. Therefore, since the external terminal 215, the wiring, and the like can be protected with a simple configuration, vibration resistance or impact resistance of the energy storage apparatus 10 can be easily improved. Since a space is formed around the external terminal 215 by arraying the projecting portion 212a projecting more than the external terminal 215, the wiring and the like can be arrayed in the space.

Since the projecting portion 212a of the end plate 212 (side member) projects more than the cover member 216 of the external terminal 215, the external terminal 215 can be protected together with the cover member 216.

Since the end plate 212 (side member) includes the recessed portions 212b and 212c in the Z-axis direction (third direction) of the projecting portion 212a, wiring or the like connected to the external terminal 215 can be disposed in the recessed portions 212b and 212c.

Since the recessed portion 212b of the end plate 212 (side member) is disposed on the side (X-axis direction (second direction)) of the external terminal 215, wiring or the like connected to the external terminal 215 can be easily disposed in the recessed portion 212b.

By arraying the recessed portion 212b1 of the end plate 212 (side member) of the first energy storage device unit 210a and the recessed portion 212b2 of the end plate 212 (side member) of the second energy storage device unit 210b at positions adjacent to each other, wiring or the like for connecting the external terminals 215 of the two energy storage device units 210 (210a, 210b) can be arrayed through the two recessed portions 212b (212b1, 212b2). The same applies to the recessed portion 212c.

The inner case side wall 350 serving as a wall portion is disposed in the Y-axis direction (first direction) of the projecting portion 212a of the end plate 212 (side member), so that the inner case side wall 350 comes into contact with the projecting portion 212a to protect the external terminal 215 and the like even when an impact is applied in the Y-axis direction (first direction) from the outside. Since the projecting portion 212a is in contact with the inner case side wall 350 (the projecting portion 212a is pressed by the inner case side wall 350), the movement of the energy storage device unit 210 can be restricted. Wiring or the like can be arrayed in a space formed by the projecting portion 212a and the inner case side wall 350.

### 5 Description of Modification Example

Although the energy storage apparatus 10 according to the embodiment of the present invention has been described above, the present invention is not limited to this embodiment. The embodiment disclosed herein is an example in all respects, and the scope of the present invention includes all modifications within the meaning and scope equivalent to the claims.

In the above-mentioned embodiment, the projecting portion 212a and the recessed portions 212b and 212c are formed at the end portions of the end plate 212 in the Y-axis minus direction. However, instead of or in addition to this, similar projecting portions and recessed portions may be formed at the end portions of the end plate 212 in the Y-axis plus direction.

In the above embodiment, the recessed portions 212b, 212c are notches formed at the corner portions of the rectangular end plate 212, but may be recessed portions formed at portions other than the corner portions of the rectangular end plate 212 and recessed in the Y-axis direction. The recessed portions 212b, 212c may be recessed portions recessed in the Z-axis direction formed at portions other than the corner portions of the rectangular end plate 212. The recessed portion 212b may not be disposed in the X-axis direction of the external terminal 215, and may be disposed at a position shifted from the X-axis direction of the external terminal 215. The two recessed portions 212b of the two end plates 212 disposed adjacently to each other in the two energy storage device units 210 disposed adjacently to each other may not be disposed adjacently to each other in the X-axis direction and may be disposed at positions shifted from each other. The same applies to the recessed portion 212c. Even with such a configuration, if the external terminal 215 and the wiring and the like can be protected by the projecting portion 212a and the wiring and the like can be arrayed by utilizing the recessed portions 212b, 212c, the use efficiency of the space in the energy storage apparatus 10 can be enhanced.

In the above embodiment, the end plate 212 includes the recessed portions 212b and 212c on both sides of the projecting portion 212a in the Z-axis direction, but may not include the recessed portion 212b or 212c. The end plate 212 may include neither the recessed portions 212b nor 212c, and the projecting portion 212a may be a portion where the entire end plate 212 in the Z-axis direction projects in the Y-axis direction. The shape of the end plate 212 in this case is, for example, a rectangle as viewed in the X-axis direction.

In the above-mentioned embodiment, in the energy storage device unit 210, the projecting portion 212a of the end plate 212 is brought into contact with the inner case side wall 350 of the inner case 300. However, the projecting portion 212a may not be brought into contact with the inner case side wall 350. The inner case 300 may not include the inner case side wall 350. Similarly, the energy storage device unit 210 may be configured such that the end plate 212 does not contact the inner case side wall 360, and the energy storage device unit 210 at the end portion may be configured such that the end plate 212 does not contact the inner case side wall 330 or 340. The inner case 300 may not include any of the inner case side walls 330, 340, and 360.

In the above-mentioned embodiment, the projecting portion 212a of the end plate 212 projects more than the cover member 216 in the Y-axis direction. However, the projecting amount of the projecting portion may be equal to that of the cover member 216, or the projecting portion may not project more than the cover member 216. The energy storage device unit 210 may not include the cover member 216. Even in these configurations, the external terminal 215, the wiring, and the like can be protected by the projecting portion 212a.

In the above embodiment, all the energy storage device units 210 included in the energy storage apparatus 10 have the above configuration, but any of the energy storage device units 210 may not have the above configuration. Both of the pair of end plates 212 included in the energy storage device unit 210 have the above configuration, but any of the end plates 212 may not have the above configuration.

In the above-mentioned embodiment, in the energy storage device unit 210, the end plate 212 is exemplified as the side member, but the side plate may be exemplified as the side member, or other members may be exemplified as the side member. In the energy storage device unit 210 of the above-mentioned embodiment, when the energy storage devices 211 which are flat in the Y-axis direction are arrayed in the Y-axis direction, the side plates are disposed at the positions of the end plates 212. In this case, as an example of the side member, the side plate may include a projecting portion projecting in the Y-axis direction more than the external terminal 215.

In the above-mentioned embodiment, the energy storage apparatus 10 may include other weights such as a weight disposed along the outer case side wall 113 or the outer case bottom wall 111 of the outer case body 110 instead of the weight 400 or in addition to the weight 400. The weight 400 may not be joined to the outer case side wall 112 by welding or the like, may be sandwiched between the inner case side wall 330 or 340 and the outer case side wall 112 and fixed to the outer case side wall 112, or may not be fixed to the outer case side wall 112.

In the above embodiment, the inner case 300 includes six walls formed separately from each other, but may be formed of two or more members formed separately from each other. The inner case 300 may have only one member. In the inner case 300, any of the six walls may be integrated, or any of the walls may not be disposed. The inner case bottom wall 320 and at least one wall of the inner case side walls 330 to 360 may be integrated (integrally formed), or the inner case upper wall 310 and at least one wall of the inner case side walls 330 to 360 may be integrated (integrally formed). At least one wall of the inner case bottom wall 320 and the inner case side walls 330 to 360 may not be disposed. The inner case 300 may have a rod-shaped beam or the like instead of the plate-shaped wall.

In the above-mentioned embodiment, the energy storage apparatus includes the inner case which houses the energy storage device unit and the outer case which houses the inner case, but the energy storage apparatus may not include the outer case.

In the above-mentioned embodiment, the energy storage apparatus includes the inner case which houses the energy storage device unit, but the energy storage apparatus may include a wall portion which is disposed in the first direction of the projecting portion of the energy storage device unit without including the inner case.

In the above embodiment, the wiring is a wiring connecting two adjacent external terminals 215, but may be a wiring connecting two non-adjacent external terminals 215. The wiring may be disposed along the X-axis direction or the Z-axis direction. The wiring may be disposed obliquely with respect to the X-axis direction or the Z-axis direction. The wiring disposed in the recessed portion may be a main circuit wiring or a control wiring. The control wiring may not be connected to the external terminal.

In the above-mentioned embodiment, the energy storage apparatus 10 is not limited to include all the above-mentioned configurations, and may not include the outer case 100, the inner case 300, the weight 400 and the like. The energy storage apparatus may be configured to include at least one energy storage device unit. As an example, one energy storage device unit 210 in the above-mentioned embodiment may be one energy storage apparatus in the present invention.

A mode constructed by arbitrarily combining the above embodiment and the above modification example is also included in the scope of the present invention.

The present invention can be applied to an energy storage apparatus or the like including an energy storage device unit including an energy storage device such as a lithium ion secondary battery.

That which is claimed is:

1. An energy storage apparatus comprising an energy storage device unit including an energy storage device and an external terminal,
wherein the external terminal is disposed on an end portion of the energy storage device unit in a first direction,
the energy storage device unit further includes a side member disposed in a second direction with respect to the energy storage device, the second direction intersecting the first direction, and
the side member includes a projecting portion projecting more than the external terminal in the first direction.

2. The energy storage apparatus according to claim 1, wherein
the energy storage device unit further includes a cover member covering the external terminal, and
the projecting portion projects more than the cover member in the first direction.

3. The energy storage apparatus according to claim 1, wherein
the side member includes a recessed portion, and
the recessed portion is disposed in the first direction with respect to the projecting portion, or is disposed in a third direction with respect to the projecting portion, the third direction intersecting the first direction and the second direction.

4. The energy storage apparatus according to claim 3, wherein the recessed portion is disposed in the second direction with respect to the external terminal.

5. The energy storage apparatus according to claim 3, further comprising a plurality of the energy storage device units,
wherein the plurality of energy storage device units includes a first energy storage device unit and a second energy storage device unit arrayed in the second direction, and
the recessed portion included in the side member of the first energy storage device unit and the recessed portion included in the side member of the second energy storage device unit are disposed adjacent to each other in the second direction.

6. The energy storage apparatus according to claim 1, further comprising a wall portion disposed in the first direction with respect to the projecting portion.

7. The energy storage apparatus according to claim 1, further comprising a plurality of the energy storage device units, wherein
the plurality of energy storage device units includes:
a first energy storage device unit including a first side member and a first recessed portion in the first side member and;
a second energy storage device unit including a second side member and a second recessed portion in the second side member,
the first energy storage device and the second energy storage device are arrayed in the second direction, and
the first recessed portion and the second recessed portion are disposed adjacent to each other in the second direction.
